(19) United States
(12) Patent Application Publication
(10) Pub. No.: US 2026/0220920 A1
(43) Pub. Date: Jul. 30, 2026

(54) GENERATIVE MACHINE LEARNING MODEL FOR OBJECT MASKING

(71) Applicant: Northeastern University, Boston, MA (US)

(72) Inventor: Eamon Conway, North Scituate, RI (US)

(21) Appl. No.: 19/343,634

(22) Filed: Sep. 29, 2025

Related U.S. Application Data
(60) Provisional application No. 63/700,954, filed on Sep. 30, 2024.

(51) Int. Cl. G06V 10/774; G06T 11/60; G06V 10/25; G06V 10/776; G06V 10/82

(52) U.S. Cl. CPC G06V 10/774; G06T 11/60; G06V 10/25; G06V 10/776; G06V 10/82

(57) ABSTRACT

A method for generating a dataset of modified images is provided. The method comprises reading a plurality of images, each image comprising at least one target, and a polygon identifying the boundaries of each target. The method comprises reading, for each target of each image, a target box identifying a region of that image comprising that target, and extracting, for each target of each image, the region identified by the target box for that target. The extracted regions are provided as input to a generative machine learning model. The method comprises reading, for each target of each image, an image patch generated by the generative machine learning model based on the extracted region for that target. The method comprises applying the image patch for each target of each image to that image according to the polygon for that target thereby generating a modified image for each image.

### CROSS REFERENCE TO RELATED APPLICATIONS

This application claims the benefit of U.S. Provisional Application No. 63/700,954, filed Sep. 30, 2024, which is hereby incorporated by reference in its entirety.

### BACKGROUND

Embodiments of the present disclosure relate to computer vision and machine learning systems, and more specifically, to generative models for creating image modifications that affect object detection performance.

### SUMMARY

According to embodiments of the present disclosure, methods of, and computer program products for, generating modified images using generative machine learning models are provided. The methods and computer program products include training generative neural networks to create image patches that reduce object detection performance, utilizing U-Net style architectures with encoding and decoding blocks, processing target objects through polygon-based masking techniques, and implementing adversarial training approaches that exploit weaknesses in computer vision detection systems.

According to an aspect of the present disclosure, a method for generating a dataset of modified images is provided. The method comprises reading a plurality of images, each image comprising at least one target. The method comprises reading, for each target of each image, a polygon identifying the boundaries of that target. The method comprises reading, for each target of each image, a target box identifying a region of that image comprising that target. The method comprises extracting, for each target of each image, the region identified by the target box for that target. The method comprises providing the extracted regions as input to a generative machine learning model. The method comprises reading, for each target of each image, an image patch generated by the generative machine learning model based on the extracted region for that target. The method comprises applying the image patch for each target of each image to that image according to the polygon for that target thereby generating a modified image for each image.

According to other aspects of the present disclosure, the method may include one or more of the following features. The at least one target of a subset of the plurality of images may comprise a plurality of targets. The generative machine learning model may be a U-Net generator. The generative machine learning model may comprise four encoding blocks, a convolutional block, four decoding blocks, an output block, and an activation layer, and the activation layer may be a Tanh activation function that outputs values within a range of (−1, +1). Applying the image patch to the image according to the polygon may comprise resizing the image patch from a predetermined size to match dimensions of the target box before applying the image patch within boundaries defined by the polygon. The method may comprise converting the extracted region from the RGB color space to the CIELAB color space before providing the extracted region as input to the generative machine learning model.

According to another aspect of the present disclosure, a method of training a generative machine learning model is provided. The method comprises reading a plurality of images, each image comprising at least one target. The method comprises reading, for each target of each image, a polygon identifying the boundaries of that target. The method comprises reading, for each target of each image, a target box identifying a region of that image comprising that target. The method comprises extracting, for each target of each image, the region identified by the target box for that target. The method comprises providing the extracted regions as input to the generative machine learning model. The method comprises reading, for each target of each image, an image patch generated by the generative machine learning model based on the extracted region for that target. The method comprises applying the image patch for each target of each image to that image according to the polygon for that target thereby generating a modified image for each image. The method comprises providing the modified images as input to a detection machine learning model. The method comprises reading, for each image, a predicted target box generated by the detection machine learning model based on the modified image for that image. The method comprises determining at least one loss value for the generative machine learning model based on the target boxes and the predicted target boxes. The method comprises updating the generative machine learning model based on the at least one loss value.

According to other aspects of the present disclosure, the method may include one or more of the following features. The at least one target of each image may comprise a plurality of targets. Applying the image patch to the image according to the polygon may comprise resizing the image patch from a predetermined size to match dimensions of the target box before applying the image patch within boundaries defined by the polygon. The at least one target of each image may comprise a first target, the predicted target box for each image may be associated with the first target of that image, and determining the at least one loss value may comprise comparing the predicted target box for each image to the target box for the first target of that image using mean squared error. The method may comprise reading a classification of the first target from the detection machine learning model. The method may comprise determining the at least one loss value may comprise determining a binary cross entropy loss based on the classifications. The method may comprise reading a confidence level for each predicted target box. Determining the at least one loss value may comprise determining whether the confidence level for each predicted target is within a predetermined region using binary cross entropy loss. Determining the at least one loss value for the generative machine learning model may comprise determining at least one loss value for the detection machine learning model and determining the at least one loss value for the generative machine learning model based on the at least one loss value for the detection machine learning model such that the at least one loss value for the generative machine learning model and the at least one loss value for the detection machine learning model are inversely related. The generative machine learning model may be trained over a plurality of epochs. The updating may comprise minimizing the at least one loss value using gradient descent. The at least one loss value may comprise a loss value for each image of the plurality of images, and the updating may comprise minimizing the at least one loss value using stochastic gradient descent. The method may comprise converting the extracted region from the RGB color space to the CIELAB color space before providing the extracted region as input to the generative machine learning model. The generative machine learning model may be a U-Net generative model. The detection machine learning model may be a You Only Look Once (YOLO) object detection model.

According to another aspect of the present disclosure, a computer system comprising one or more processors to train a generative machine learning model is provided. The computer system is configured to read a plurality of images, each image comprising at least one target. The computer system is configured to read, for each target of each image, a polygon identifying the boundaries of that target. The computer system is configured to read, for each target of each image, a target box identifying a region of that image comprising that target. The computer system is configured to extract, for each target of each image, the region identified by the target box for that target. The computer system is configured to provide the extracted regions as input to the generative machine learning model. The computer system is configured to read, for each target of each image, an image patch generated by the generative machine learning model based on the extracted region for that target. The computer system is configured to apply the image patch for each target of each image to that image according to the polygon for that target thereby generating a modified image for each image. The computer system is configured to provide the modified images as input to a detection machine learning model. The computer system is configured to read, for each image, a predicted target box generated by the detection machine learning model based on the modified image for that image. The computer system is configured to determine at least one loss value for the generative machine learning model based on the target boxes and the predicted target boxes. The computer system is configured to update the generative machine learning model based on the at least one loss value.

### BRIEF DESCRIPTION OF THE DRAWINGS

FIG. 1 is a flow diagram depicting an exemplary method for training a generative machine learning model, in accordance with one or more embodiments of the present disclosure.

FIG. 2 is a flow diagram depicting an exemplary method for generating a dataset of modified images, in accordance with one or more embodiments of the present disclosure.

FIGS. 3A-3B depicts exemplary ground truth target boxes and polygons, according to one or more embodiments of the present disclosure.

FIGS. 4A-4E depict an exemplary generative machine learning model, according to one or more embodiments of the present disclosure.

FIG. 5 depicts training metrics graphs, according to one or more embodiments of the present disclosure.

FIG. 6 depicts exemplary inferences on a training dataset, according to one or more embodiments of the present disclosure.

FIG. 7 depicts training loss and performance metrics graphs for model convergence, according to one or more embodiments of the present disclosure.

FIG. 8 depicts inferences on original and modified images, according to one or more embodiments of the present disclosure.

FIG. 9 depicts a computing node, in accordance with one or more embodiments of the present disclosure.

### DETAILED DESCRIPTION

Various embodiments relate to systems and methods for generating modified images using machine learning techniques. Computer vision and object detection systems have become increasingly prevalent across various applications, including autonomous vehicles, security systems, and image analysis platforms. These systems rely on sophisticated machine learning models to identify and classify objects within images and video streams.

Various embodiments provide a method for generating a dataset of modified images by utilizing annotated training data and machine learning models to selectively mask target objects within images. Various embodiments provide a method for training a generative machine learning model. The system processes annotated images containing target objects with associated polygons and target boxes, extracts regions of interest, and applies machine learning-generated image patches to mask the depiction of targets while maintaining visual coherence. This approach enables the modification of images where specific objects are effectively concealed or altered in appearance.

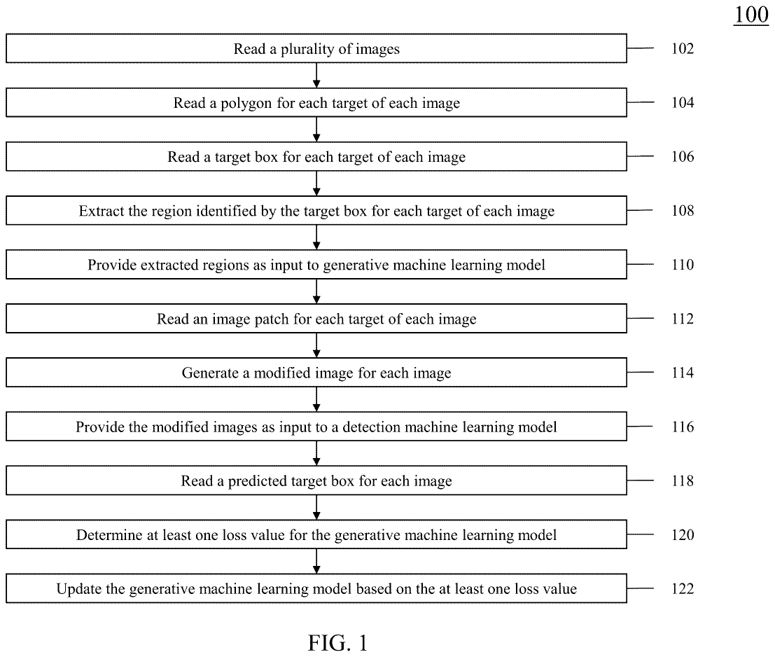

With reference now to FIG. 1, the method for training a generative machine learning model involves a systematic process.

Operation 102 comprises reading a plurality of images, where each image comprises at least one target. The images may be obtained through various methods and sources depending on the specific implementation requirements. In some embodiments, the images may be accessed from memory, including but not limited to persistent memory such as hard drives, solid-state drives, flash memory, or other non-volatile storage devices, or transient memory such as random access memory (RAM), cache memory, or other volatile storage systems. In other embodiments, the images may be downloaded or retrieved from a remote source, such as a server, cloud storage platform, networked database, or distributed storage system accessible through network connections. The images may be selected, captured, or extracted from a video stream, including live video feeds from cameras or sensors, recorded video files stored in various formats, streaming media sources, or real-time video data from surveillance systems or other imaging devices. The system may be configured to handle images in various formats and resolutions, with the capability to process different image sizes as needed for the specific application requirements.

A target may refer to a collection of pixels depicting an object of interest within the image data, such as vehicles, people, buildings, or other identifiable entities that the system is designed to process and analyze. The target represents a specific region or object within the image that has been annotated or identified for training purposes, with associated metadata including spatial boundaries and classification information.

In some cases, the at least one target of each image comprises a plurality of targets, allowing the system to process multiple objects within a single image simultaneously. This multi-target capability enables the system to handle complex scenes containing various objects of interest, where each target may represent different object classes or multiple instances of the same object class. The system maintains separate processing pipelines for each target within an image, ensuring that individual object characteristics and spatial relationships are preserved throughout the training and inference processes.

The training process utilizes annotated training data that includes target identification information for each object of interest within the image dataset. This annotated data may comprise ground truth labels, bounding box coordinates, polygon boundaries defining precise object contours, classification labels that specify the object type or category, and/or other information. The annotation process may be performed manually by human annotators or through automated labeling systems, with quality control measures ensuring accuracy and consistency across the dataset. The training data serves as the foundation for teaching the generative machine learning model to recognize and process target objects effectively.

The generative machine learning model may be a U-Net generative model that processes input regions to generate corresponding image patches for masking applications. The U-Net architecture employs an encoder-decoder structure with skip connections that preserve spatial information while enabling the model to learn both local and global features of the input targets. This architecture is particularly well-suited for image-to-image translation tasks, where the model may generate output patches that maintain spatial coherence with the input regions while achieving the desired masking or modification effects. The generative model learns to create patterns and modifications that can be applied to target objects while preserving the overall visual integrity of the processed images.

Operation 104 comprises reading, for each target of each image, a polygon identifying the boundaries of that target. The polygon data may provide precise geometric information that defines the contours and spatial boundaries of each target object within the image coordinate system. This polygon information may be stored as a series of coordinate points that define the perimeter or outline of the target object, enabling accurate identification of which pixels belong to the target object versus the background or other elements within the image. The polygon boundaries may be represented using various geometric formats, such as a sequence of (x, y) coordinate pairs that trace the object's perimeter, or as a collection of vertices that define the object's shape through connected line segments.

The polygon data serves multiple functions in the training and processing pipeline. First, it acts as a mask that determines the exact spatial extent of each target object, providing pixel-level accuracy for object boundary definition. This precision ensures that generated image patches are applied only to the intended target regions while preserving the integrity of surrounding image content. Second, the polygon information enables the system to distinguish between multiple overlapping or adjacent targets within a single image, maintaining clear separation between different objects of interest. Third, the polygon boundaries provide the spatial constraints necessary for accurate pattern application during the masking process, ensuring that modifications remain confined to the target regions.

The polygon reading process may comprise parsing annotation files or data structures that contain the geometric information for each target object. These annotations may be stored in various formats, including but not limited to JSON files containing coordinate arrays, XML markup with polygon definitions, or specialized annotation formats used by computer vision labeling tools. The system may be capable of interpreting different coordinate systems and scaling factors to ensure proper alignment between the polygon data and the corresponding image pixels. The polygon information may include metadata such as object identifiers, classification labels, or confidence scores that provide additional context for the training process.

Operation 106 comprises reading, for each target of each image, a target box identifying a region of that image comprising that target. The target box defines a rectangular bounding region that encompasses the target object within the image coordinate system, providing spatial coordinates that specify the location and dimensions of the area containing the target. These target boxes may be represented using various coordinate systems, including corner coordinates that define the top-left and bottom-right points of the rectangular region, or center point coordinates combined with width and height dimensions that specify the central location and size of the bounding area. The target box information serves as a coarse-grained regional identifier that works in conjunction with the polygon data to provide both broad spatial context and detailed boundary information for each target object. The reading process may comprise accessing annotation data structures that contain the geometric information for each target box, which may be stored in formats such as JSON arrays, XML markup, or specialized computer vision annotation formats used by labeling tools and datasets.

Operation 108 comprises extracting, for each target of each image, the region identified by the target box for that target. In some cases, the extracted region may be converted from the RGB color space to the CIELAB color space before providing the extracted region as input to the generative machine learning model. This color space conversion can enhance the model's ability to process color information in a perceptually uniform manner, improving quality and consistency of the generated image patches.

Alternative color space conversions may be employed depending on the specific requirements of the generative machine learning model and the characteristics of the target objects. For example, the extracted region may be converted from the RGB color space to the HSV (Hue, Saturation, Value) color space, which separates color information from intensity and can be particularly effective for applications where color consistency is important while lighting conditions may vary. In other implementations, the extracted region may be converted to the YUV color space, which separates luminance from chrominance components and can provide advantages for processing images with varying brightness levels or when computational efficiency is a priority.

The conversion process may involve transforming the extracted region to the XYZ color space as an intermediate step for more complex color transformations. This provides device-independent color representation. In some embodiments, the extracted region may be converted to grayscale representation by computing weighted averages of the RGB channels, which can reduce computational complexity while maintaining structural information for pattern generation. The system may be configured to automatically select the most appropriate color space conversion based on the characteristics of the training dataset, such as lighting conditions, color distribution, or object types.

The color space conversion may include normalization steps to ensure consistent value ranges across different color channels. For instance, when converting to CIELAB color space, the L channel values may be normalized to a range of [0, 100], while the a and b channels may be normalized to ranges of [−128, 127] or converted to normalized ranges such as [−1, 1] to match the input requirements of the generative machine learning model. The conversion process may incorporate gamma correction or other color adjustment techniques to account for display characteristics or camera response curves in the original image data.

This color space conversion can enhance the model's ability to process color information in a perceptually uniform manner. The extracted regions serve as input data for the generative machine learning model to produce corresponding modifications.

Operation 110 comprises providing the extracted regions as input to the generative machine learning model. The extracted regions represent cropped portions of the original images that contain the target objects, with each region defined by the spatial boundaries of the corresponding target box coordinates. These regions serve as the primary input data for the generative machine learning model to process and analyze the visual characteristics of the target objects.

The provision of extracted regions to the generative machine learning model involves several technical considerations and processing steps. The extracted regions may be formatted and preprocessed to meet the specific input requirements of the generative machine learning model architecture. This preprocessing may comprise one or more of normalization of pixel values to ensure consistent input ranges, resizing operations to match the expected input dimensions of the model, and data augmentation techniques to improve the robustness of the training process.

The generative machine learning model receives these extracted regions as batch inputs during the training process, where multiple regions from different images may be processed simultaneously to improve computational efficiency. The model architecture is designed to handle variable input sizes and different visual characteristics across the extracted regions, enabling it to learn generalizable patterns and features that can be applied to diverse target objects within the dataset.

The input provision process may involve memory management considerations, particularly when processing large datasets with high-resolution images. The system may implement buffering mechanisms, data loading strategies, and memory optimization techniques to ensure efficient utilization of computational resources while maintaining the integrity of the input data throughout the processing pipeline.

Operation 112 comprises reading, for each target of each image, an image patch generated by the generative machine learning model based on the extracted region for that target. The image patch reading process may comprise retrieving the output data produced by the generative machine learning model after processing the extracted regions through its neural network architecture. Each image patch represents a modified or transformed version of the corresponding extracted region, containing pixel-level modifications that have been generated based on the learned patterns and features of the generative model.

The generative machine learning model may produce these image patches as output tensors or arrays containing pixel values that correspond to the spatial dimensions of the input extracted regions. The image patches may maintain the same resolution and aspect ratio as the input regions to ensure proper alignment during the subsequent application process. The pixel values within each image patch may be normalized to specific ranges depending on the activation function used in the output layer of the generative model, such as values within the range of (−1, +1) when using a Tanh activation function.

The reading operation may comprise accessing the generated image patches from the model's output buffer or memory allocation, where they are stored after the forward pass computation through the generative neural network. This process may involve data type conversions, memory management operations, and format standardization to ensure compatibility with subsequent processing steps. The system may handle multiple image patches simultaneously when processing batches of extracted regions, requiring efficient memory allocation and data organization strategies.

The image patches generated by the generative machine learning model may contain the visual modifications that will be applied to the original target objects during the masking process. These patches are designed to achieve specific visual effects while maintaining spatial coherence and visual plausibility within the context of the original image content. The quality and effectiveness of the generated image patches depend on the training state of the generative model and its ability to learn appropriate patterns from the training dataset.

Operation 114 comprises applying the image patch for each target of each image to that image according to the polygon for that target. Applying the image patch for each target of a given image generates a modified image for the given image. In some cases, applying the image patch to the image according to the polygon comprises resizing the image patch from a predetermined size to match dimensions of the target box before applying the image patch within boundaries defined by the polygon. This resizing operation ensures that the generated patches align properly with the original target dimensions while maintaining the spatial constraints defined by the polygon boundaries.

The application process involves several technical considerations to ensure accurate and visually coherent integration of the generated image patches with the original image content. The system may handle coordinate transformations between the standardized patch dimensions produced by the generative machine learning model and the variable dimensions of the target boxes in the original images. This transformation process may involve interpolation techniques such as bilinear interpolation, bicubic interpolation, or nearest neighbor interpolation to maintain image quality during the resizing operation.

The polygon boundaries serve as precise spatial identifiers that determine which pixels within the target box region are modified by the generated patch. The system may implement pixel-level masking operations that evaluate each pixel's position relative to the polygon boundaries, applying the generated patch values only to pixels that fall within the polygon interior while preserving the original pixel values for areas outside the polygon boundaries. This selective application process ensures that the masking effects are confined to the target objects without affecting surrounding image content or background elements.

The masking operation may involve alpha blending or other compositing techniques to achieve smooth transitions between the generated patch content and the original image pixels at the polygon boundaries. The system may implement anti-aliasing techniques to reduce visual artifacts that could occur at the edges of the polygon boundaries, particularly when the polygon coordinates do not align precisely with pixel boundaries. These techniques help maintain visual continuity and prevent noticeable discontinuities or sharp edges that could compromise the quality of the modified images.

The coordinate system alignment process ensures that the polygon boundaries, which are defined in the original image coordinate space, are properly mapped to the resized patch dimensions during the application process. This alignment may involve scaling transformations, translation operations, and coordinate system conversions to maintain spatial accuracy between the polygon definitions and the patch application regions. The system may account for rounding errors or precision limitations that could occur during coordinate transformations, implementing appropriate error handling and correction mechanisms to maintain spatial accuracy.

The generated modified images may maintain the same overall dimensions and format as the original input images, with only the target regions modified according to the applied patches. The system preserves all metadata, color space information, and other image properties while selectively modifying the pixel values within the target regions. This approach ensures compatibility with downstream processing systems and maintains the integrity of the image dataset structure throughout the masking operation.

Operation 116 comprises providing the modified images as input to a detection machine learning model, which may be a You Only Look Once (YOLO) object detection model or other suitable detection architecture. The detection machine learning model processes the modified images and generates predictions for target locations and classifications. Operation 118 comprises reading, for each image, a predicted target box generated by the detection machine learning model based on the modified image for that image. In some cases, the at least one target of each image comprises a first target, and the predicted target box for each image may be associated with the first target of that image. The detection model may generate additional outputs including confidence levels and classification results for the detected targets.

Operation 120 comprises determining at least one loss value for the generative machine learning model based on the target boxes and the predicted target boxes. This determination process includes comparing the predicted target box for each image to the target box for the first target of that image using mean squared error, which quantifies the spatial accuracy of the detection results. The method may comprise reading a classification of the first target from the detection machine learning model. Determining at least one loss value may comprise determining a binary cross entropy loss based on the classifications. The method may comprise reading a confidence level for each predicted target box. Determining the at least one loss value may comprise determining whether the confidence level for each predicted target is within a predetermined region using binary cross entropy loss.

The loss calculation methodology may comprise determining at least one loss value for the generative machine learning model comprising determining at least one loss value for the detection machine learning model and determining the at least one loss value for the generative machine learning model based on the at least one loss value for the detection machine learning model such that the at least one loss value for the generative machine learning model and the at least one loss value for the detection machine learning model are inversely related. This inverse relationship enables the generative model to learn patterns that reduce the detection performance of the target detection system. The at least one loss value comprises a loss value for each image of the plurality of images, allowing the system to process multiple training examples simultaneously during batch training operations.

Operation 122 comprises updating the generative machine learning model based on the at least one loss value, where the updating comprises minimizing the at least one loss value using gradient descent or stochastic gradient descent optimization techniques. The generative machine learning model may be trained over a plurality of epochs, with each epoch involving multiple iterations through the training dataset to progressively improve the model's performance. In some cases, stochastic gradient descent may be employed when the at least one loss value comprises a loss value for each image of the plurality of images, enabling efficient processing of large datasets through mini-batch optimization. The iterative training process allows the generative model to learn increasingly effective patterns for generating image patches that achieve the desired masking effects while maintaining visual coherence with the original image content.

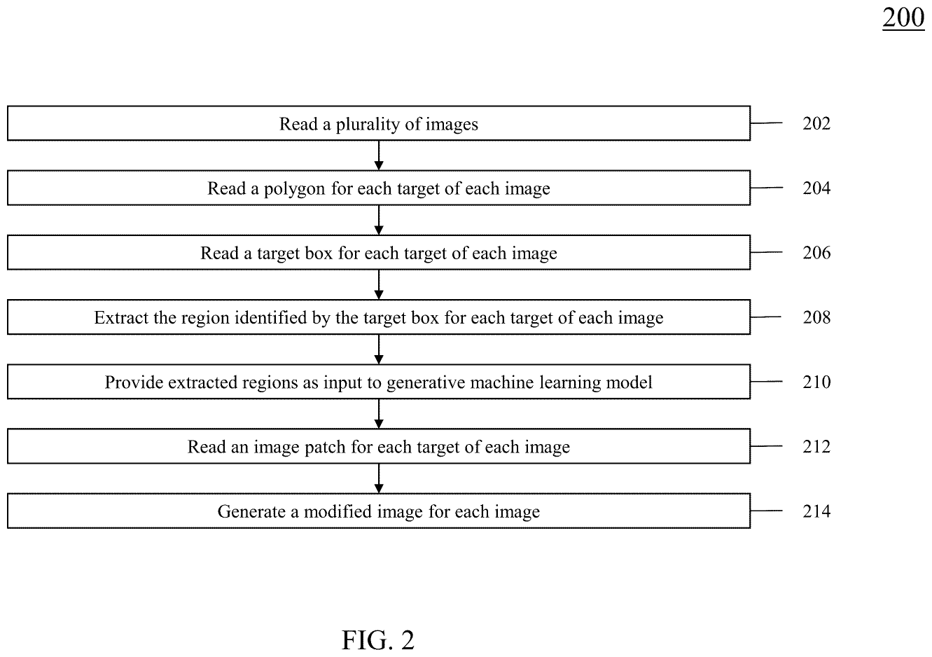

With reference now to FIG. 2, the method for generating a dataset of modified images provides a systematic approach for processing annotated image data to create modified images where target objects are selectively masked. The method begins with operation 202, which comprises reading a plurality of images, where each image comprises at least one target. In some cases, the at least one target of a subset of the plurality of images comprises a plurality of targets, allowing the system to handle complex scenes containing multiple objects of interest simultaneously. The images may be stored in various formats and resolutions, with the system configured to process different image sizes as needed for the specific application requirements.

Operation 204 comprises reading, for each target of each image, a polygon identifying the boundaries of that target. The polygon data provides precise geometric information defining the exact contours and boundaries of each target object within the image.

This polygon information may be stored as a series of coordinate points that define the perimeter of the target object, enabling accurate identification of which pixels belong to the target versus the background. The polygon boundaries serve as masks that determine where generated image patches will be applied during the masking process, ensuring that modifications are confined to the target regions while preserving the surrounding image content.

The method continues with operation 206, which comprises reading, for each target of each image, a target box identifying a region of that image comprising that target. The target box defines a rectangular bounding region that encompasses the target object, providing spatial coordinates that specify the location and dimensions of the area containing the target. These target boxes may be represented using various coordinate systems, such as corner coordinates or center point with width and height dimensions. The target box information works in conjunction with the polygon data to provide both coarse-grained regional information and fine-grained boundary details for each target object.

Operation 208 comprises extracting, for each target of each image, the region identified by the target box for that target. This extraction process may comprise cropping or isolating the rectangular region defined by the target box coordinates from the original image.

The extracted regions contain the visual content of the target objects along with any surrounding context within the bounding box boundaries. In some embodiments, the method comprises converting the extracted region from the RGB color space to the CIELAB color space before providing the extracted region as input to the generative machine learning model.

As shown in operation 210, the method comprises providing the extracted regions as input to a generative machine learning model. The generative machine learning model may be a U-Net generator that processes the input regions to generate corresponding image patches for masking applications. In some cases, the generative machine learning model comprises four encoding blocks, a convolutional block, four decoding blocks, an output block, and an activation layer. The activation layer may be a Tanh activation function that outputs values within a range of (−1, +1), providing normalized output values that can be effectively applied to the original image content. The U-Net architecture enables the model to capture both local and global features of the input regions while maintaining spatial resolution through skip connections between encoding and decoding layers.

Operation 212 comprises reading, for each target of each image, an image patch generated by the generative machine learning model based on the extracted region for that target. The generated image patches represent modified versions of the original target regions, created by the generative model to achieve specific visual effects or modifications. These patches maintain the same spatial dimensions as the input regions and contain pixel-level modifications that will be applied to mask or alter the appearance of the target objects. The generative model produces these patches based on learned patterns and features extracted from the training data, enabling consistent and effective masking across different target instances.

The final operation 214 comprises applying the image patch for each target of each image to that image according to the polygon for that target, thereby generating a modified image for each image. In some cases, applying the image patch to the image according to the polygon comprises resizing the image patch from a predetermined size to match dimensions of the target box before applying the image patch within boundaries defined by the polygon. This resizing operation ensures proper alignment between the generated patches and the original target dimensions while maintaining visual coherence. The polygon boundaries serve as precise masks that determine which pixels within the target box region are modified by the generated patch, allowing for accurate application of the masking effects while preserving the integrity of non-target areas within the image.

Various embodiments refer to a system for dataset generation and/or model training operations. For example, the system may be configured to perform one or more operations of method 100 depicted in FIG. 1 and/or method 200 depicted in FIG. 2. The system comprises a generative machine learning model configured to process extracted image regions and generate corresponding image patches for masking applications. The generative machine learning model may be configured with any number of filters. For example, the generative machine learning model comprises 64 filters. The system may be configured to process images of various dimensions. For example, the system is configured to process images with 640×640 pixels representing one example size configuration. Larger or smaller image dimensions may be utilized depending on the specific application requirements. The system architecture supports flexible configuration parameters that allow adaptation to different computational environments and performance requirements.

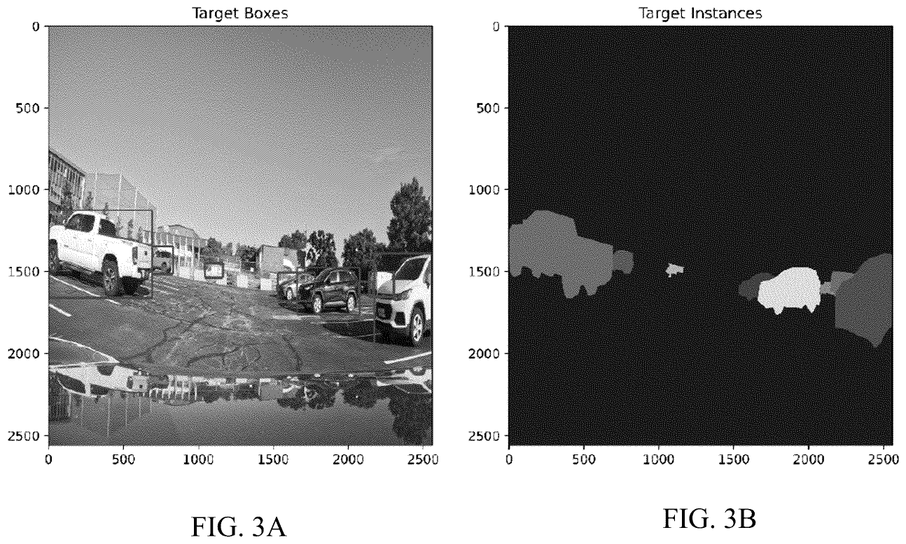

To train the generative model, various embodiments utilize images, a bounding box of each target, a polygon of the target within each image, a pre-trained detection model, and/or other information or machine learning models. FIG. 3 illustrates an example of ground truth data, where the individual target boxes are shown in FIG. 3A. The instances are illustrated in FIG. 3B. The data illustrated in FIGS. 3A and 3B was collected using parked vehicles as targets.

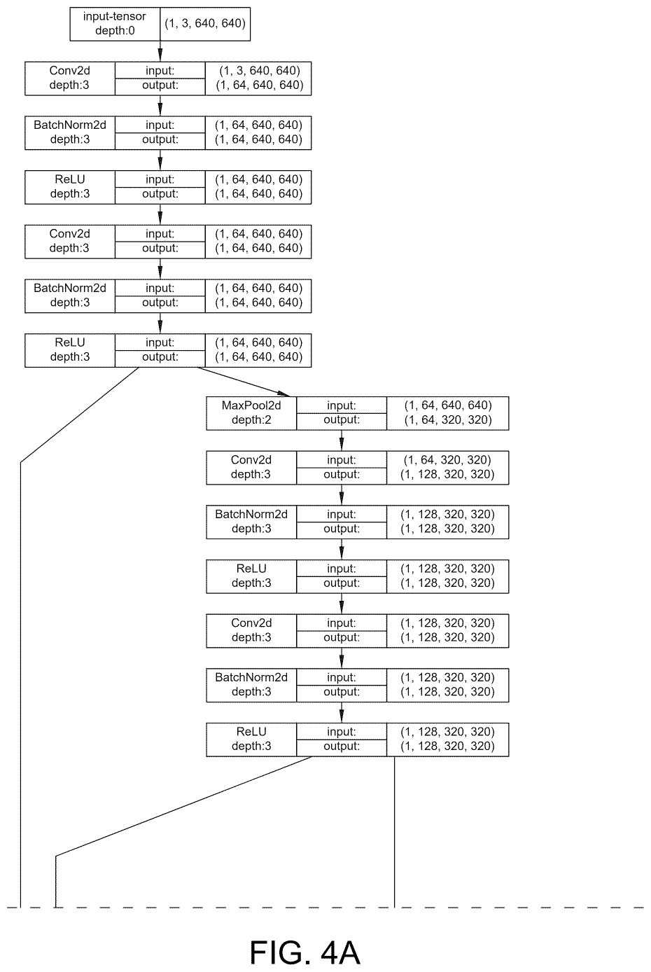

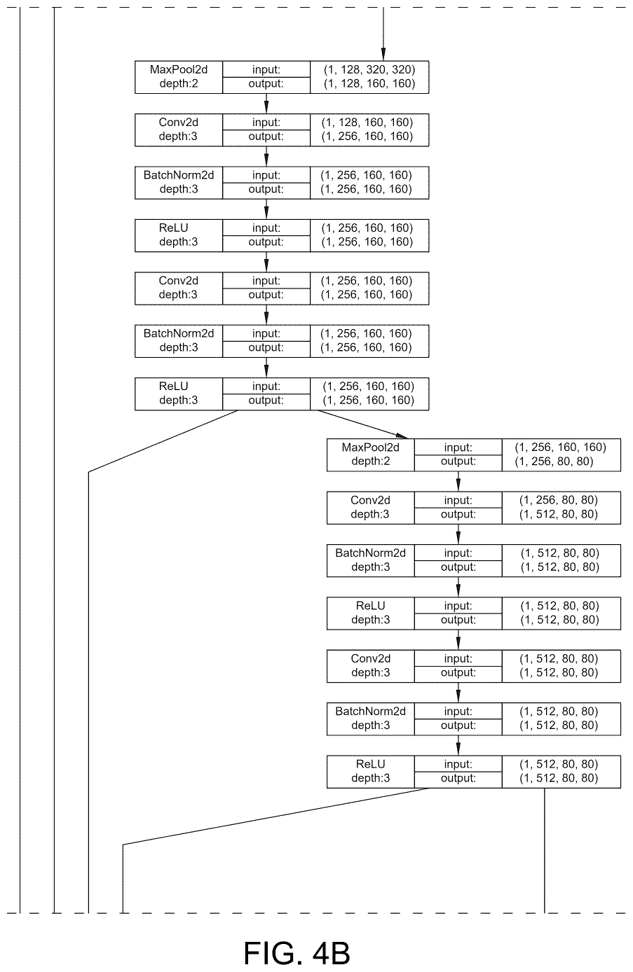

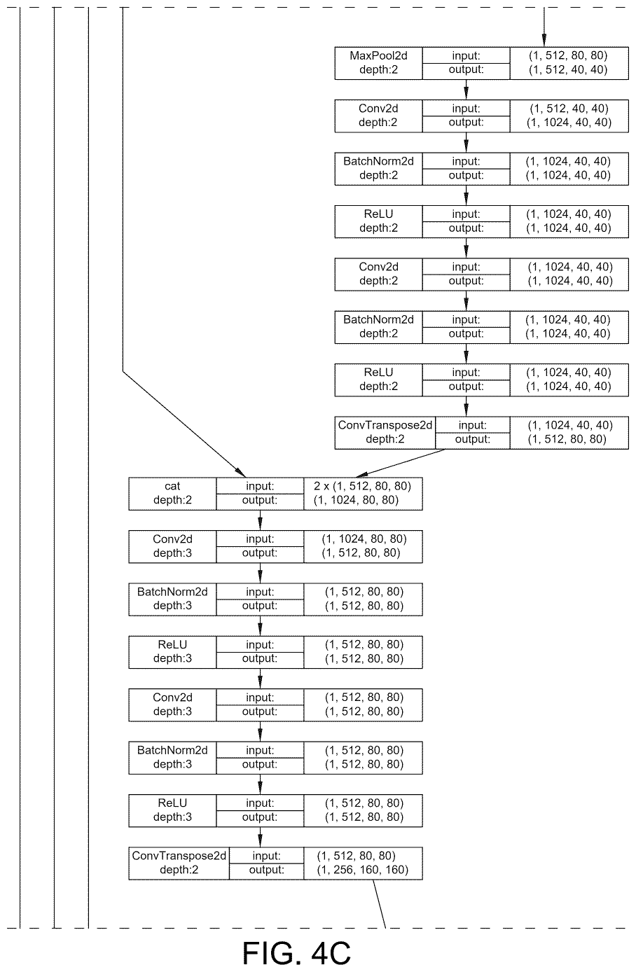

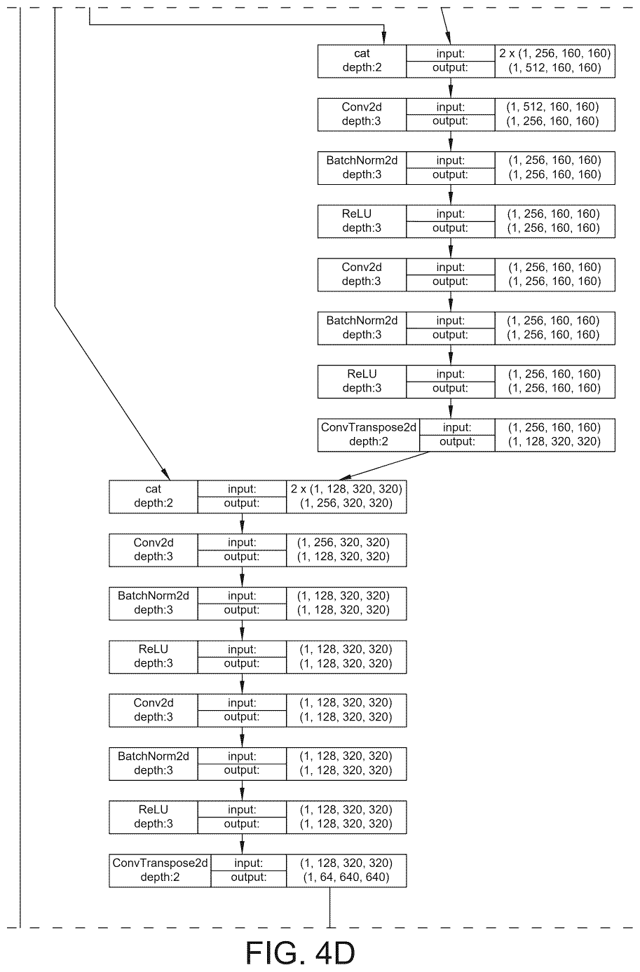

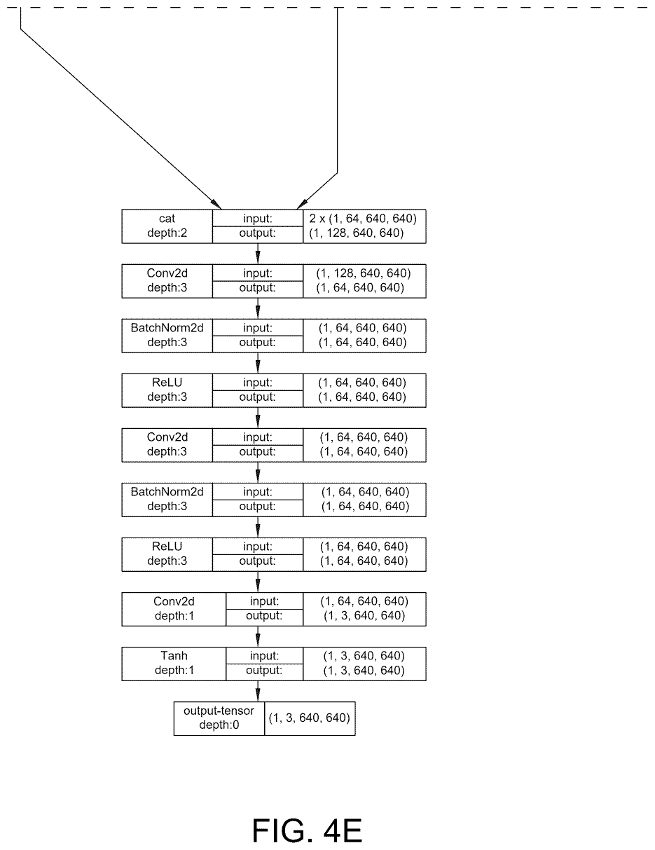

With reference now to FIGS. 4A-4E, a visual representation of an exemplary U-Net style generative model is illustrated. In an exemplary embodiment, the generator has 64 layers and parses images of size (640×640), though other layer counts and image sizes may be utilized. The generator may be designed on a U-Net style convolutional neural network model.

For example, the generative machine learning model may comprise a plurality of encoding blocks, a convolutional block, a plurality of decoding blocks, an output block, and an activation layer. The activation layer may be the final layer. In the exemplary embodiment shown in FIGS. 4A-4E, the generator comprises four encoding blocks and four decoding blocks. Within each encoder block, a convolution block may be utilized where convolution layers are applied, with each convolution optionally followed by batch normalization and an activation layer such as a ReLU activation layer. For example, at least one of the convolutional layers is a 3×3 convolution layer. At the end of each encoder block, a pooling layer may be applied. The pooling layer may be a max pooling layer, an average pooling layer, and/or another type of pooling layer. For example, the pooling layer is a (2,2) max pooling layer. The encoder block may return both the inputs and outputs from the pooling layer, where the inputs may be utilized as skip-connections during the decoding.

Exemplary encoder blocks are illustrated within the cells of FIGS. 4A-4E (excluding the input tensor). These four successive encoder blocks make up an encoder of an exemplary U-Net generator. At the base of the exemplary U-Net generator, which is the first set of blocks in FIG. 4C, the convolution block may be utilized again. For the decoding section of the U-Net generator, the decoder blocks may utilize a 2×2 kernel. Upsampling techniques may be used to increase the spatial dimensions of the input, optionally followed by concatenation with skip-connections from corresponding encoder blocks. The concatenated features may be processed through convolution block. Exemplary decoder blocks are presented as the second set of blocks in FIG. 4C (excluding the cat block) and the sets of blocks in FIGS. 4D-4E (excluding the “cat” blocks). The output layer may comprise a convolutional layer that outputs the desired number of channels for the image format being processed. For example, an exemplary output layer has a 1 ×1 ) kernel size: this is three for RGB imagery. The final layer may be an activation function. For example, the activation is Tanh, ReLU, Leaky ReLU, Sigmoid, or another activation function. For example, the activation function outputs values within a specified range such as (−1,+1).

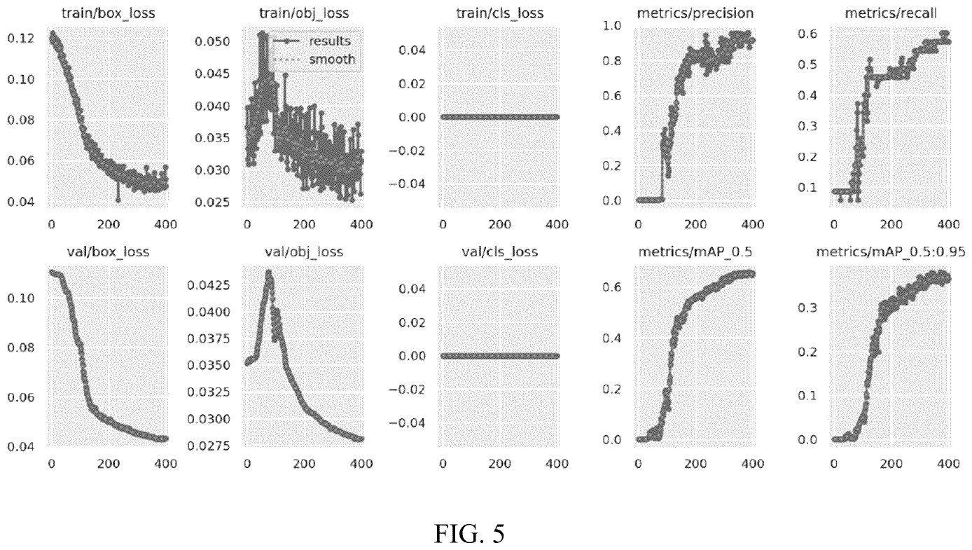

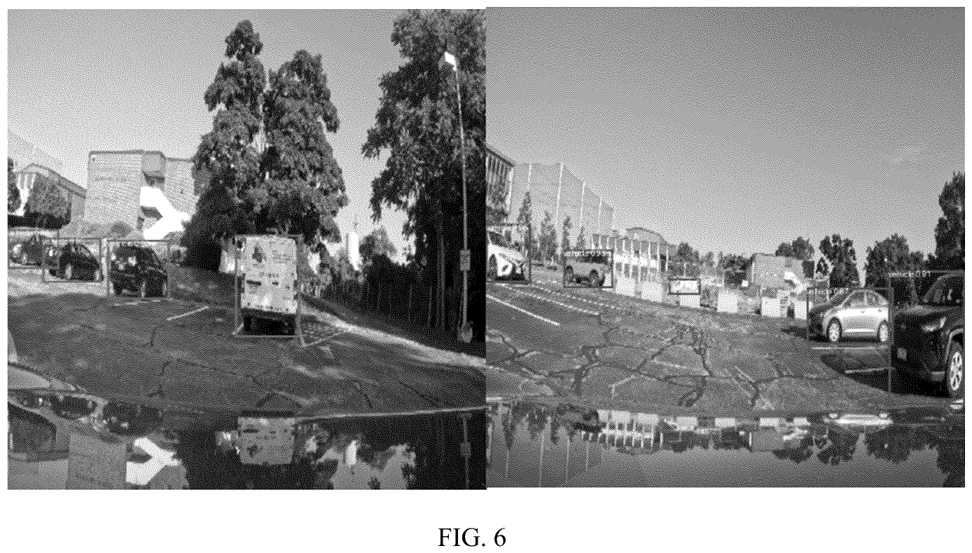

Various embodiments utilize an object detection model as a detection machine learning model. However, reference to use of a detection machine learning model is merely exemplary. In some implementations, the detection machine learning model may comprise an instance segmentation model and/or a segmentation model that relates to image classification tasks. For example, the detection machine learning model may utilize the YOLOv5 medium v6 model with an image size of 640×640. For example, during training of the detection machine learning model, the learning rate may be set to 0.001, the batch size may be 16 and the number of epochs may be 400. In FIG. 5, the learning metrics are illustrated. In FIG. 6, example inferences on a vehicle detection dataset are showcased. It was observed that loss metrics gradually decrease, while the accuracy metrics increase. This trained object detector may be utilized as the detection machine learning model in various embodiments.

Data preprocessing may be performed prior to training the generative machine learning model. The preprocessing may comprise reading each annotated image path into memory. For each image path, the path to the respective instance mask file may be retrieved. For each image path, the path to the respective target box file may be retrieved. The preprocessing may comprise reading each image into memory. The image may be resized to predetermined dimensions. For example, the image may be resized to 640×640. This is an exemplary configuration for demonstration purposes, but larger or smaller sizes may be used. The preprocessing may comprise reading each instance mask into memory. The preprocessing may comprise extracting each individual polygon mask per target and/or the centroid of the polygon. The preprocessing may comprise reading into memory each set of ground truth target boxes per image. The preprocessing may comprise rescaling the coordinates to match the predetermined dimensions.

To begin the training phase, the U-Net style generative model may be initialized, meaning the number of filters is specified during program execution (e.g., 64 filters) together with the image size to be parsed through its layers, which may be set to (32 32) . It is subsequently loaded onto GPU memory which may be accomplished using PyTorch, in the Python coding language. For training, exemplary embodiments use a batch size of 8, a learning rate of 0.001, set the number of epochs to 12,000, and use a stochastic gradient descent.

During each batch, within each training epoch, one or more data processing steps may be performed. The batch may comprise a list of indices that point to an image, its respective polygons, and target boxes that have been processed into memory. For each index, an image, its respective polygons, its respective target boxes, and/or other information may be retrieved. Each individual target box may be matched to a polygon instance based on the distance between their centroid coordinates. A second set of polygon instances may be created with shifted coordinates such that their centroid lies at a predetermined point. In various embodiments the predetermined point is (0,0) and the centroid coordinates are subtracted from all polygon coordinates. A ‘small image’ may be extracted that consists of the pixels within the target box and resized to match the U-Net style generative model input requirement. This ‘small image’ may be converted to CIELAB (lab) space. This ‘small image’ may be parsed through the generative machine learning model. The inferenced ‘small image’ may then be resized back to its original shape, determined by the target box coordinates. Utilizing the polygon instance of the target, the pattern produced by the generator may be applied to the instance mask within the original image.

Upon completion of these steps, the images within each batch have had their target instances updated with a generative pattern produced by the generative model. The next step introduces loss metrics and utilizes the pre-trained YOLOv5 detector. The first loss metric may minimize the difference between the original target box and the updated target instance. The mean absolute error between the original target box and the updated target box for each image within the batch may be calculated (i.e., the L1 Loss metric). Within the same batch, the newly patterned images may be parsed, with the ground truth targets, through the detector. One or more loss metrics may be considered. The loss metrics may comprise an objective loss, a box loss, a classification loss, and/or other loss metrics. The objective loss may be determined based on the confidence a target is within a proposed region using Binary Cross Entropy loss. The box loss may be determined based on bounding box regression loss calculated using Mean Squared Error. The classification loss may be determined based on Binary Cross Entropy loss in target class determination.

One or more of the objective loss, box loss, classification loss, and/or other loss metrics may be summed to determine a loss value for the detection machine learning model. A loss value for the generation machine learning model may be determined based on the loss value for the detection machine learning model. For example, performance of the generative machine learning model and performance of the detection machine learning model are inversely related. The loss value for the generative machine learning model may then be added to the L1 loss to obtain a total loss value. The generative machine learning model may be trained using the total loss value.

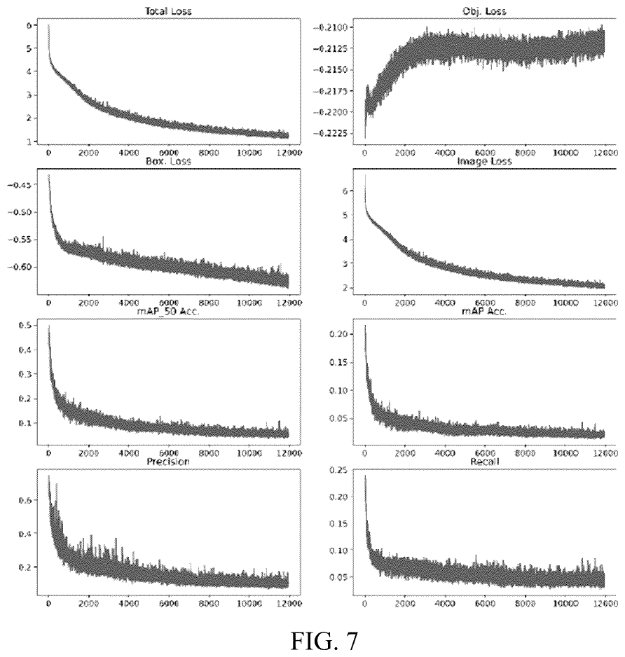

The training results for the exemplary implementation described herein are shown in FIG. 7. FIG. 7 shows box loss, objectiveness loss, image-loss (1.1-loss), mean-average procession at a 50% intersection over union threshold, mean-average procession for intersection over union thresholds ranging from 50% to 95%, recall, and precision, as a function of epochs.

It was observed that the box and image loss metrics were reduced, enabling prospective targets to deceive perceptive systems that utilize optical sensors as their method of detection. The image (L1) loss was also observed as being reduced with epochs, gradually minimizing the difference between the patterned and non-patterned targets. In regard to accuracy, both mean average precision scores smoothly decreased over time, reducing from 0.5 to 0.1, and 0.25 to 0.05 for the respective mAP_50% and mAP 50%: 95% metrics. Both precision and recall metrics likewise decreased with time, indicating that the YOLOv5 model is inadequate at detecting patterned vehicles with confidence.

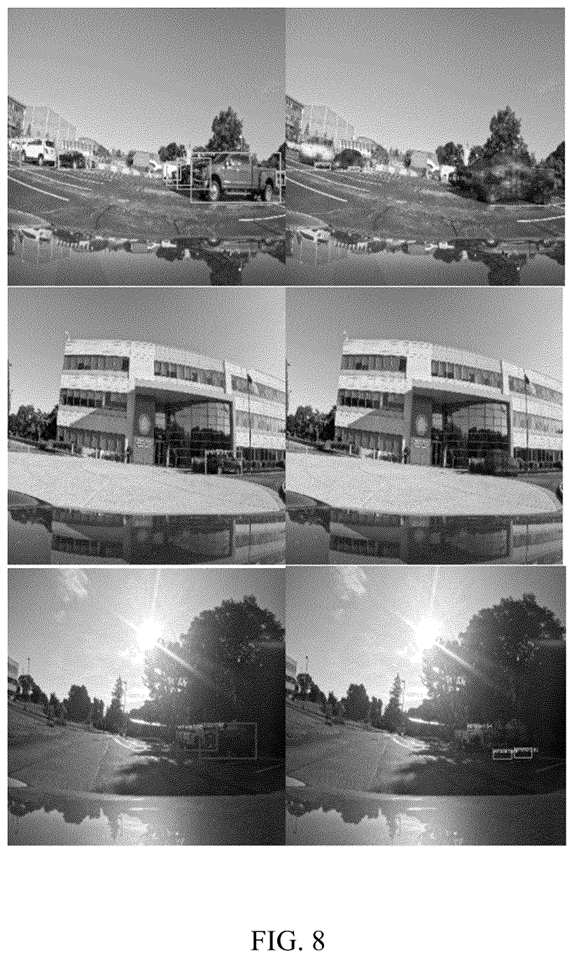

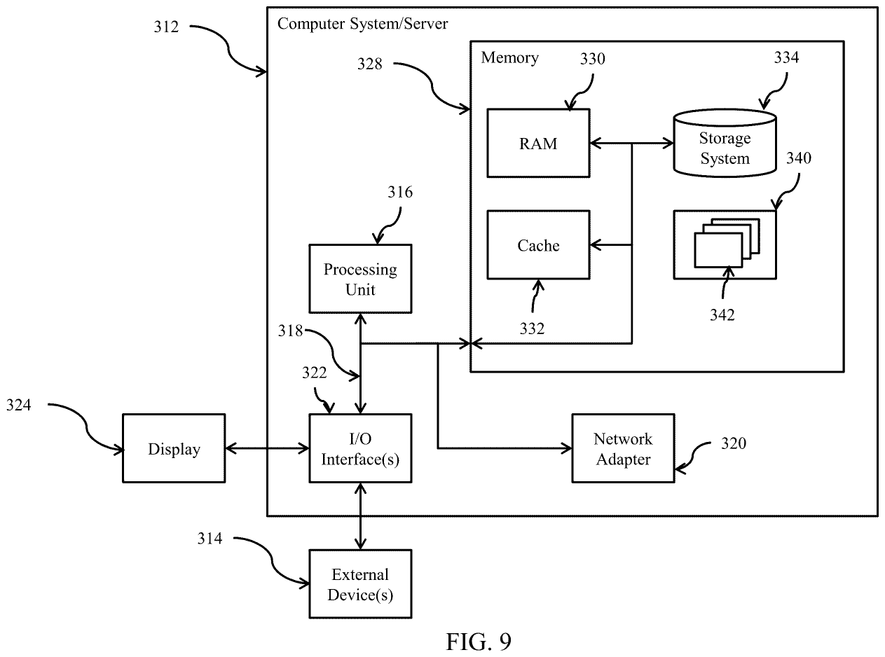

FIG. 7 illustrates training metrics for the generative neural network (U-Net style) that enables object to deceive a perceptive network (YOLOv5). In FIG. 7, three example predictions are showcased, where in the left column, the original, pretrained YOLOv5 detector correctly performs an inference on unperturbed targets. The right column of FIG. 7, illustrates when the generated pattern has been applied to the target and how the detector may not perceive targets. The minimum confidence threshold may be set to 15% for inferencing. FIG. 8 illustrates inferences on raw, un-perturbed imagery (left column) using the pretrained YOLOv5 detector. Inferences on images that the generative neural network (U-Net style) has applied patterns that enable objects to deceive a perceptive network (YOLOv5) (right column).

Referring now to FIG. 9, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove, including the training of generative machine learning models, the processing of image datasets with target objects and polygon boundaries, the execution of U-Net style convolutional neural networks, and the implementation of adversarial training approaches for object masking applications.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. The computer system/server 12 is particularly well-suited for machine learning applications that require substantial computational resources, such as training generative neural networks with multiple encoding and decoding blocks, processing large datasets of annotated images, and performing iterative optimization using gradient descent algorithms.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. In the context of the present disclosure, these program modules may include machine learning frameworks such as PyTorch or TensorFlow, image processing libraries for handling RGB to CIELAB color space conversions, polygon processing algorithms for boundary detection and masking operations, and neural network training modules that implement stochastic gradient descent optimization. Computer system/server 12 may be practiced in distributed cloud computing environments where tasks are performed by remote processing devices that are linked through a communications network. In a distributed cloud computing environment, program modules may be located in both local and remote computer system storage media including memory storage devices, enabling distributed training of generative models across multiple computing nodes for improved performance and scalability.

As shown in FIG. 9, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16. The processors or processing units 16 may include central processing units (CPUs) optimized for sequential processing tasks, graphics processing units (GPUs) particularly well-suited for parallel processing operations required in neural network training and inference, and specialized processing units such as tensor processing units (TPUs) designed specifically for machine learning workloads. The system memory 28 provides storage for training datasets containing annotated images with target objects, polygon boundary data, target box coordinates, and the parameters and weights of the generative machine learning models during training and inference operations.

Bus 18 represents one or more of any of several types of bus structures, including a memory bus or memory controller, a peripheral bus, an accelerated graphics port, and a Substitute processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA). For machine learning applications, high-bandwidth bus architectures such as PCIe are particularly advantageous for enabling rapid data transfer between system memory and specialized processing units, facilitating efficient batch processing of image data and real-time parameter updates during neural network training.

Computer system/server 12 typically includes a variety of computer system readable media. Such media may be any available media that is accessible by computer system/server 12, and it includes both volatile and non-volatile media, removable and non-removable media. The computer system readable media may store various types of data relevant to the disclosed methods, including training image datasets with multiple targets per image, annotation files containing polygon coordinates and target box definitions, pre-trained detection model parameters for YOLO or other object detection architectures, and intermediate processing results such as extracted image regions and generated image patches.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure, including the implementation of U-Net style generative models with encoding blocks, convolutional blocks, decoding blocks, and activation layers, the processing of target object regions through polygon-based masking techniques, and the execution of adversarial training procedures that utilize inverse loss relationships between generative and detection machine learning models.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein, including but not limited to the implementation of generative machine learning models for object masking applications, the execution of U-Net style convolutional neural networks with encoding and decoding blocks, the processing of annotated image datasets containing target objects with polygon boundaries and target box coordinates, the implementation of adversarial training algorithms that utilize inverse loss relationships between generative and detection models, and the coordination of batch processing operations for training dataset preparation and model optimization procedures.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. In the context of machine learning applications for object masking, these external devices may include specialized input devices for annotating training images with polygon boundaries and target box coordinates, high-resolution displays for visualizing the results of generative model training and the effectiveness of applied image patches, and network interfaces for accessing distributed training datasets or cloud-based computational resources.

Such communication can occur via Input/Output (I/O) interfaces 22, which may be optimized for high-bandwidth data transfer operations required for processing large image datasets and streaming training data to GPU processing units. Still yet, computer system/server 12 can communicate with one or more networks such as a local area network (LAN), a general wide area network (WAN), and/or a public network (e.g., the Internet) via network adapter 20. These network connections enable distributed training scenarios where multiple computing nodes collaborate on training generative machine learning models, facilitate access to cloud-based storage systems containing annotated image datasets, and support real-time collaboration between researchers working on adversarial training approaches for computer vision applications. As depicted, network adapter 20 communicates with the other components of computer system/server 12 via bus 18. It should be understood that although not shown, other hardware and/or software components could be used in conjunction with computer system/server 12. Examples include, but are not limited to: microcode optimized for neural network operations, specialized device drivers for GPU acceleration of machine learning workloads, redundant processing units for fault-tolerant training operations, external disk drive arrays for storing large-scale image datasets with target annotations, RAID systems configured for high-throughput data access patterns typical of machine learning applications, tape drives for archival storage of trained model parameters and experimental results, and data archival storage systems designed to preserve training datasets and model checkpoints for reproducibility and long-term research continuity.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the Substitute functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In various embodiments, a vector of features that includes machine learning model input(s) may be provided to one or more of the machine learning models described herein. Based on the input features, one or more of the machine learning models described herein may generate one or more outputs. In some embodiments, the output(s) of the one or more machine learning models described herein may be a vector of features.

A machine learning model is a computational system that can learn from data and perform tasks such as classification, regression, clustering, or generation. A machine learning model typically consists of a set of parameters that define its structure and behavior, and a training algorithm that adjusts these parameters based on a given objective function. In various embodiments, the one or more machine learning models, described herein, may be pre-trained using training data. In various embodiments, training data may be retrospective data. In various embodiments, the retrospective data may be stored in a datastore. In various embodiments, the one or more machine learning models, described herein, may be additionally trained through manual curation of previously generated outputs.

In various embodiments, the one or more machine learning models, described herein, may be and/or may include a dynamic programming algorithm and/or model, such as a dynamic linear programming algorithm/model or a dynamic nonlinear programming algorithm/model. In various embodiments, the one or more machine learning models, described herein, may be a trained classifier, a trained regression model, a clustering model, a generation model, and/or another type of model. In various embodiments, the trained classifier may be a random decision forest. However, it will be appreciated that a variety of other classifiers are suitable for use according to the present disclosure, including linear classifiers, support vector machines (SVM), or artificial neural network models, such as generative adversarial networks (GANs), a long short-term memory (LSTM) model, and/or recurrent neural networks (RNNs).

Suitable artificial neural network models include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, a transformer, or a deep Q-network.

One or more machine learning models described herein may be trained in epochs and/or batches. An epoch is a complete pass through the entire training dataset. A batch is a subset of the training dataset that is processed at a time. For example, all batches may be processed during each epoch. A machine learning model may be updated after processing of each batch.

A machine learning model may be updated during training based on its loss and/or an optimization algorithm. Loss is determined using a loss function. A loss function is a mathematical expression that measures the discrepancy between the output of the model and the desired output, such as the ground truth labels or the target values. A loss function quantifies the error or the cost of the model's predictions. A loss function provides a signal for the training algorithm to update the model's parameters. Different loss functions may be suitable for different types of tasks and models and may have different properties and implications. Suitable loss functions include but are not limited to mean squared error (MSE), Cross-entropy, Kullback-Leibler divergence (KL divergence), contrastive, hinge, mean absolute error (MSE), Huber, Log-Cosh, and quantile loss

An optimization algorithm is a numerical method that iteratively updates the model's parameters based on the gradient of the loss function with respect to the parameters. An optimization algorithm aims to find the optimal or the best set of parameters that minimizes the loss function, or equivalently, maximizes the objective function. Suitable optimization algorithms include but are not limited to gradient descent, stochastic gradient descent (SGD), Adam, batch gradient descent, mini-batch gradient descent, momentum, Nesterov accelerated Gradient (NAG), adaptive gradient algorithm (Adagrad), and root mean squared propagation.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method generating a dataset of modified images, the method comprising:
reading a plurality of images, each image comprising at least one target;
reading, for each target of each image, a polygon identifying the boundaries of that target;
reading, for each target of each image, a target box identifying a region of that image comprising that target;
extracting, for each target of each image, the region identified by the target box for that target;
providing the extracted regions as input to a generative machine learning model;
reading, for each target of each image, an image patch generated by the generative machine learning model based on the extracted region for that target; and
applying the image patch for each target of each image to that image according to the polygon for that target thereby generating a modified image for each image.

2. The method of claim 1, wherein the at least one target of a subset of the plurality of images comprises a plurality of targets.

3. The method of claim 1, wherein the generative machine learning model is a U-Net generator.

4. The method of claim 3, wherein the generative machine learning model comprises four encoding blocks, a convolutional block, four decoding blocks, an output block, and an activation layer, and wherein the activation layer is a Tanh activation function that outputs values within a range of (−1, +1).

5. The method of claim 1, wherein applying the image patch to the image according to the polygon comprises resizing the image patch from a predetermined size to match dimensions of the target box before applying the image patch within boundaries defined by the polygon.

6. The method of claim 1, further comprising converting the extracted region from the RGB color space to the CIELAB color space before providing the extracted region as input to the generative machine learning model.

7. A method of training a generative machine learning model, the method comprising:
reading a plurality of images, each image comprising at least one target;
reading, for each target of each image, a polygon identifying the boundaries of that target;
reading, for each target of each image, a target box identifying a region of that image comprising that target;
extracting, for each target of each image, the region identified by the target box for that target;
providing the extracted regions as input to the generative machine learning model;
reading, for each target of each image, an image patch generated by the generative machine learning model based on the extracted region for that target;
applying the image patch for each target of each image to that image according to the polygon for that target thereby generating a modified image for each image;
providing the modified images as input to a detection machine learning model;
reading, for each image, a predicted target box generated by the detection machine learning model based on the modified image for that image;
determining at least one loss value for the generative machine learning model based on the target boxes and the predicted target boxes; and
updating the generative machine learning model based on the at least one loss value.

8. The method of claim 7, wherein the at least one target of each image comprises a plurality of targets.

9. The method of claim 7, wherein applying the image patch to the image according to the polygon comprises resizing the image patch from a predetermined size to match dimensions of the target box before applying the image patch within boundaries defined by the polygon.

10. The method of claim 7, the at least one target of each image comprising a first target, the predicted target box for each image being associated with the first target of that image, said determining the at least one loss value comprises comparing the predicted target box for each image to the target box for the first target of that image using mean squared error.

11. The method of claim 7, the method further comprising reading a classification of the first target from the detection machine learning model, and said determining the at least one loss value comprises determining a binary cross entropy loss based on the classifications.

12. The method of claim 7, the method further comprising reading a confidence level for each predicted target box, and wherein said determining the at least one loss value comprises determining whether the confidence level for each predicted target is within a predetermined region using binary cross entropy loss.

13. The method of claim 7, said determining the at least one loss value for the generative machine learning model comprising:
determining at least one loss value for the detection machine learning model; and
determining the at least one loss value for the generative machine learning model based on the at least one loss value for the detection machine learning model such that the at least one loss value for the generative machine learning model and the at least one loss value for the detection machine learning model are inversely related.

14. The method of claim 7, the generative machine learning model being trained over a plurality of epochs.

15. The method of claim 7, said updating comprising minimizing the at least one loss value using gradient descent.

16. The method of claim 7, the at least one loss value comprising a loss value for each image of the plurality of images, said updating comprising minimizing the at least one loss value using stochastic gradient descent.

17. The method of claim 7, further comprising converting the extracted region from the RGB color space to the CIELAB color space before providing the extracted region as input to the generative machine learning model.

18. The method of claim 7, wherein the generative machine learning model is a U-Net generative model.

19. The method of claim 7, wherein the detection machine learning model is a You Only Look Once (YOLO) object detection model.

20. A computer system comprising one or more processors to train a generative machine learning model, the computer system configured to:
read a plurality of images, each image comprising at least one target;
read, for each target of each image, a polygon identifying the boundaries of that target;
read, for each target of each image, a target box identifying a region of that image comprising that target;
extract, for each target of each image, the region identified by the target box for that target;
provide the extracted regions as input to the generative machine learning model;
reading, for each target of each image, an image patch generated by the generative machine learning model based on the extracted region for that target;
apply the image patch for each target of each image to that image according to the polygon for that target thereby generating a modified image for each image;
provide the modified images as input to a detection machine learning model;
read, for each image, a predicted target box generated by the detection machine learning model based on the modified image for that image;
determine at least one loss value for the generative machine learning model based on the target boxes and the predicted target boxes; and
update the generative machine learning model based on the at least one loss value.
